(19) United States
(12) Patent Application Publication
(10) Pub. No.: US 2026/0074240 A1
(43) Pub. Date: Mar. 12, 2026

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Susono-shi (JP); Keiichi OKUBO, Susono-shi (JP); Kimihiro TSUCHIYA, Fuji-shi (JP)

(73) Assignee: TOYOTA JIDOSHA KABUSHIKI KAISHA, Toyota-shi (JP)

(21) Appl. No.: 19/270,973

(22) Filed: Jul. 16, 2025

(30) Foreign Application Priority Data
Sep. 10, 2024 (JP) 2024-156773

(51) Int. Cl. H01M 4/86; H01M 4/88; H01M 4/92; H01M 8/10; H01M 8/1004

(52) U.S. Cl. CPC H01M 4/8663; H01M 4/881; H01M 4/925; H01M 8/1004; H01M 2008/1095

(57) ABSTRACT

In this embodiment, an anode catalyst layer disposed on one surface of the solid polymer electrolyte membrane and the other surface of the solid polymer electrolyte membrane are provided. A membrane electrode assembly having a cathode catalyst layer disposed thereon, wherein the membrane electrode assembly comprises a metallic ions selected from cerium ions and manganese ions and a host compound capable of forming a clathrate compound with the metallic ions, wherein the cathode catalyst layer comprises an electrode catalyst, a binder, and an organic nitrogen-containing compound, wherein the electrode catalyst comprises a metal-supported catalyst comprising a catalyst metal and a support supporting the catalyst metal, and wherein the organic nitrogen-containing compound is at least one compound selected from the group consisting of a compound of formula (1), a compound of formula (2), and a compound of formula (3), or a polymer thereof.

### CROSS-REFERENCE TO RELATED APPLICATION

This application claims priority to Japanese Patent Application No. 2024-156773 filed on Sep. 10, 2024, incorporated herein by reference in its entirety.

### BACKGROUND

### 1. Technical Field

The present disclosure relates to a membrane electrode assembly.

### 2. Description of Related Art

A polymer electrolyte fuel cell generally includes a membrane electrode assembly (also referred to as a “MEA”) having a solid polymer electrolyte membrane that is an electrolyte membrane, an anode catalyst layer that is disposed on one face of the solid polymer electrolyte membrane, and a cathode catalyst layer that is disposed on the other face of the solid polymer electrolyte membrane. The anode catalyst layer functions as a fuel electrode, and the cathode catalyst layer functions as an air electrode. A gas diffusion layer may be further disposed on both faces of the MEA, and this form is referred to as a membrane electrode gas diffusion layer assembly (also referred to as “MEGA”). Now, in a polymer electrolyte fuel cell, hydrogen peroxide (H₂O₂) may be generated from water and oxygen in a catalyst layer during power generation, and hydroxyl radicals (·OH) may be generated from the hydrogen peroxide. The hydrogen peroxide and the hydroxyl radicals are factors causing degradation of electrolytic resins such as ionomers that are contained in solid polymer electrolyte membranes and catalyst layers.

Therefore, technology has been proposed in which a radical quenching agent, such as cerium ions or the like, is contained in the MEA, so as to render harmless the hydrogen peroxide radicals that are generated during power generation by the fuel cell. To render harmless the hydrogen oxide radicals is, for example, reaction from hydrogen peroxide radicals into water.

For example, Japanese Unexamined Patent Application Publication No. 2008-130460 (JP 2008-130460 A) discloses a solid polymer electrolyte membrane that is made of a polymeric electrolyte having a sulfonate group and that contains any one of (a) to (c) below [(a) cerium ions and an organic compound (X) that is capable of forming a clathrate compound with cerium ions, (b) a clathrate compound (Y) made up of the organic compound (X) enveloping cerium ions, (c) at least one of cerium ions and the organic compound (X), and the clathrate compound (Y)]. JP 2008-130460 A describes that the solid polymer electrolyte membrane in JP 2008-130460 A has excellent resistance with respect to hydrogen peroxide or peroxide radicals. While the reason thereof is not clear, including the cerium ions and the organic compound (X) in the electrolyte membrane forms a clathrate compound of at least part of these. Description is made therein regarding a hypothesis that the clathrate compound interacts with a sulfonate group (—SO₃⁻) to form a predetermined structure by ion exchange of part of the sulfonate group with the clathrate compound (Y), thereby effectively improving hydrogen peroxide or peroxide radical resistance of the polymer electrolyte membrane.

Also, for example, Vo Dinh Cong Tinh et al., “Enhancement of oxidative stability of PEM fuel cell by introduction of HO radical scavenger in Nafion ionomer”, Journal of Membrane Science 613 (2020) 118517, discloses a membrane electrode assembly (MEA) in which coordination complexes of 18-crown-6-ether/cerium ions (CRE/Ce) are embedded in a Nafion ionomer between a catalyst and a membrane. Description is made that Ce serves to scavenge HO-radicals, and CRE mitigates elution of cerium ions from the MEA during cell operation (Summary, etc.).

### SUMMARY

As described above, JP 2008-130460 A and Vo Dinh Cong Tinh et al., “Enhancement of oxidative stability of PEM fuel cell by introduction of HO radical scavenger in Nafion ionomer”, Journal of Membrane Science 613 (2020) 118517 disclose an anode catalyst layer containing 18-crown-6-ether together with cerium ions, as a radical quenching agent. One of problems with cerium ions is the decrease in durability due to decrease in concentration arising due to movement of ions, but JP 2008-130460 A and Vo Dinh Cong Tinh et al., “Enhancement of oxidative stability of PEM fuel cell by introduction of HO radical scavenger in Nafion ionomer”, Journal of Membrane Science 613 (2020) 118517, describe that adding 18-crown-6-ether enables elution of cerium ions to the outside of the MEA to be mitigated.

However, investigation performed using a membrane electrode assembly containing a radical quenching agent such as cerium ions or the like and a crown ether compound such as 18-crown-6-ether or the like found reduced performance, and it became evident that there is room for improvement in terms of power generation performance and durability.

Accordingly, an object of the present disclosure is to provide a membrane electrode assembly that has excellent power generation performance and durability.

The present inventors, through diligent study to solve the above problems, found that the reason for the voltage drop is that the crown ether compound that is contained in the membrane electrode assembly, such as in the anode catalyst layer, the electrolyte membrane, and so forth, migrates to the cathode catalyst layer and poisons the catalyst metal. The present inventors then further studied and found that a membrane electrode assembly that has excellent power generation performance and durability can be provided by including a predetermined nitrogen-containing heterocyclic compound or a polymer thereof in a cathode catalyst layer, and thus the present disclosure has been achieved.

Accordingly, an example of the aspect of the present embodiment is as follows.
(1) A membrane electrode assembly includes
a solid polymer electrolyte membrane,
an anode catalyst layer that is disposed on one face of the solid polymer electrolyte membrane, and
a cathode catalyst layer that is disposed on another face of the solid polymer electrolyte membrane, in which
the membrane electrode assembly includes metallic ions that are selected from cerium ions and manganese ions, and a host compound that is configured to create a clathrate compound with the metallic ions,
the cathode catalyst layer includes an electrode catalyst, a binder, and an organic nitrogen-containing compound,
the electrode catalyst includes a metal-carried catalyst including a catalyst metal and a carrier that carries the catalyst metal, and
the organic nitrogen-containing compound is at least one compound that is selected from a group consisting of a compound of Formula (1) below, a compound of Formula (2) below, and a compound of Formula (3) below, or a polymer of the compound that is selected,

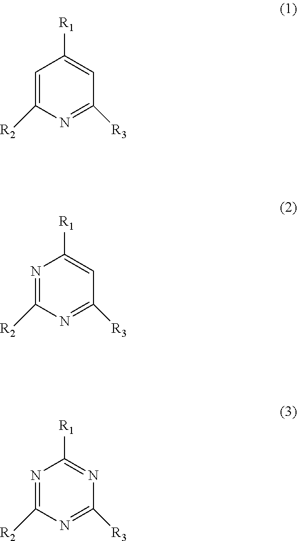

where, in Formulae (1) through (3), R₁, R₂, and R₃ are each independently an amino group, a thiol group, a hydroxyl group, an alkylamino group with 1 to 10 carbon atoms, or an alkyl group with 1 to 10 carbon atoms, in which at least one of the carbon atoms in the alkylamino group and the alkyl group may be substituted with an oxygen atom, a sulfur atom, or a nitrogen atom, and at least one of hydrogen atoms in the alkylamino group and the alkyl group may be substituted with a fluorine atom, a chlorine atom, a bromine atom, or an iodine atom.
(2) In the membrane electrode assembly according to (1), the host compound is a crown ether compound or a salt of the crown ether compound.
(3) In the membrane electrode assembly according to (2), molecular weight of the host compound is no less than 300.
(4) In the membrane electrode assembly according to (2) or (3), the host compound is a crown ether compound with an aromatic ring or an aliphatic ring, or a salt of the crown ether compound.
(5) In the membrane electrode assembly according to any one of (1) to (4), the catalyst metal includes at least one type that is selected from a group consisting of platinum particles, platinum alloy particles, and composite particles containing platinum.

According to the present disclosure, a membrane electrode assembly that has excellent power generation performance and durability can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view for explaining a configuration example of a membrane electrode assembly and a polymer electrolyte fuel cell according to the present embodiment, and is a cross-sectional view of a main part of a fuel cell 10 as an example.

### DETAILED DESCRIPTION OF EMBODIMENTS

The present embodiment is a membrane electrode assembly including a solid polymer electrolyte membrane, an anode catalyst layer disposed on one surface of the solid polymer electrolyte membrane, and a cathode catalyst layer disposed on the other surface of the solid polymer electrolyte membrane. The membrane electrode assembly includes metallic ions selected from a cerium ion and a manganese ion, and a host compound capable of forming a clathrate compound with the metallic ions. The cathode catalyst layer includes an electrode catalyst, a binder, and an organic nitrogen-containing compound. The electrode catalyst includes a metal-supported catalyst including a catalyst metal and a support supporting the catalyst metal. The organic nitrogen-containing compound is at least one compound selected from the group consisting of the compound of formula (1), the compound of formula (2), and the compound of formula (3), or a polymer thereof.

According to the present embodiment, it is possible to provide a membrane electrode assembly excellent in power generation performance and durability. In the present embodiment, cerium ions and/or manganese ions, which function as a radical quenching agent, are added to a membrane electrode assembly (e.g., an anode catalyst layer or a solid polymer electrolyte membrane). Since hydrogen peroxide radicals can be trapped and rendered harmless by cerium ions and/or manganese ions, degradation of the membrane electrode assembly can be suppressed. Further, by adding the host compound for the metallic ions to the membrane electrode assembly, the migration of the metallic ions can be suppressed, and the deviation of the concentration in the plane direction can be reduced. Further, in the membrane electrode assembly according to the present embodiment, poisoning of a catalyst metal (for example, platinum) by a host compound such as a crown ether compound can be suppressed by including the organic nitrogen-containing compound in the cathode catalyst layer. Thus, performance degradation such as power generation performance (initial voltage) and durability can be suppressed. It has been confirmed that the organic nitrogen-containing compound activates the catalyst metal, and it is presumed that the power generation performance (initial voltage) can be improved by including the organic nitrogen-containing compound in the cathode catalyst layer. Further, by including the organic nitrogen-containing compound in the cathode catalyst layer, surprisingly, it was confirmed that poisoning of the catalyst metal by the host compound is also suppressed, and the voltage maintenance ratio after the durability test was also improved. For the above reasons, according to the present embodiment, a membrane electrode assembly excellent in power generation performance and durability can be provided.

Hereinafter, the configuration of the present embodiment will be described.

### Membrane Electrode Assembly

The solid polymer electrolyte membrane has a function of preventing the flow of electrons and gases, and transferring protons (H⁺) generated at the anode from the anode-side catalyst layer to the cathode-side catalyst layer. As the solid polymer electrolyte membrane in the present embodiment, an electrolyte membrane having proton conductivity known in the art can be used. As the solid polymer electrolyte membrane, for example, a membrane formed of a fluororesin (Nafion (manufactured by Du Pont Co., Ltd.), Flemion (manufactured by AGC Co., Ltd.), Aciplex (manufactured by Asahi Kasei Co., Ltd.), or the like) having a sulfonate group, which is an electrolyte, can be used.

The thickness of the solid polymer electrolyte membrane is not particularly limited, but is, for example, 5 μm to 50 μm from the viewpoint of improving proton conductivity.

The cathode catalyst layer functions as an air electrode (oxygen electrode). The cathode catalyst layer in the present embodiment includes at least an electrode catalyst, a binder, and an organic nitrogen-containing compound. The binder is preferably an ionomer. The electrode catalyst is a metal-supported catalyst in which metal particles having catalytic activity are supported on a support. That is, the electrode catalyst is a metal-supported catalyst including a catalyst metal and a support that supports the catalyst metal.

As a method of supporting the catalyst metal on the support, a method conventionally used can be employed. For example, there is a method in which particulate catalyst metal is mixed with a carrier dispersion liquid in which a carrier is dispersed, filtered, washed, redispersed in ethanol or the like, and then dried by a vacuum pump or the like. After drying, if necessary, heat treatment may be performed.

The support is not particularly limited, and examples thereof include carbon and oxides. The carbon may be carbon having electronic conductivity. The carrier may be used singly or in a combination of two or more.

Examples of the carbon support include carbon black (acetylene black, Ketjen black, furnace black, or the like), activated carbon, graphite, glassy carbon, graphene, carbon fiber, carbon nanotube, carbon nitride, sulfurized carbon, and phosphated carbon. As the carbon support, one kind may be used alone, or two or more kinds may be used in combination.

Examples of the oxide support include titanium oxide, niobium oxide, tin oxide, tungsten oxide, and molybdenum oxide. One kind of the oxide support may be used alone, or two or more kinds thereof may be used in combination.

The carrier is preferably a carrier having pores, and is preferably a carbon carrier having pores.

The catalyst metal is not particularly limited as long as it exhibits a catalytic action in the reaction at the electrode.

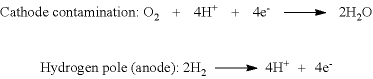

The catalyst metal is not particularly limited, and for example, platinum, palladium, rhodium, gold, silver, osmium, iridium, or an alloy of two or more thereof can be used. The platinum alloy is not particularly limited, but an alloy of platinum and at least one of aluminum, chromium, manganese, iron, cobalt, nickel, gallium, zirconium, molybdenum, ruthenium, rhodium, palladium, vanadium, tungsten, rhenium, osmium, iridium, titanium, and lead can be used, for example. The catalyst metal is preferably at least one selected from the group consisting of platinum particles, platinum alloy particles, and composite particles containing platinum. One kind of the catalyst metal may be used alone, or two or more kinds thereof may be used in combination.

The content of the electrode catalyst in the cathode catalyst layer is not particularly limited, but is, for example, 3 to 40 mass % with respect to the total mass of the catalyst layer.

The cathode catalyst layer in the membrane electrode assembly according to the present embodiment includes the organic nitrogen-containing compound. The organic nitrogen-containing compound is at least one compound selected from the group consisting of a compound of formula (1), a compound of formula (2) and a compound of formula (3), or a polymer thereof. When the organic nitrogen-containing compound is contained in the cathode catalyst layer, poisoning of a catalyst metal (for example, platinum) by a host compound such as a crown ether compound can be suppressed. Thus, performance degradation such as power generation performance (initial voltage) and durability can be suppressed. It is confirmed that the organic nitrogen-containing compound activates the catalyst metal, and it is presumed that poisoning of the catalyst metal by the host compound is suppressed by including the organic nitrogen-containing compound in the cathode catalyst layer.

In the formulae (1) to (3), the number of carbon atoms of the alkylamino group and the alkyl group is 1 to 10, preferably 1 to 6, preferably 1 to 4, and preferably 1 to 3. The alkyl group may be straight-chain or branched.

The organic nitrogen-containing compound in the present embodiment may be at least one compound selected from the group consisting of a compound of the formula (1), a compound of the formula (2), and a compound of the formula (3). The organic nitrogen-containing compound in the present embodiment may be a polymer containing at least one compound selected from the group consisting of a compound represented by the formula (1), a compound represented by the formula (2), and a compound represented by the formula (3) as a polymerization component. The polymer is preferably a polymer obtained by condensation polymerization of a component containing at least one compound selected from the group consisting of the compound of formula (1), the compound of formula (2), and the compound of formula (3), and aldehydes such as methanal (formaldehyde), ethanal, or propanal. A particularly preferred aldehyde is formaldehyde. The polymer is preferably a polymer obtained by condensation polymerization of melamine and formaldehyde. The method for producing the polymer is not particularly limited, and may be, for example, a known method.

The content of the organic nitrogen-containing compound in the cathode catalyst layer is not particularly limited, and can be appropriately selected in view of the effects of the present embodiment. The content of the organic nitrogen-containing compound in the cathode catalyst layer is preferably, for example, from 0.01 to 0.3 by weight with respect to the platinum catalyst.

The organic nitrogen-containing compound can be contained in the cathode catalyst layer by, for example, the following method. For example, the organic nitrogen-containing compound may be contained in a metal-supported catalyst. For example, in forming a metal-supported catalyst, an organic nitrogen-containing compound may be added and mixed with a particulate catalyst metal in a carrier dispersion in which a carrier is dispersed. According to the method, the organic nitrogen-containing compound is preferably disposed close to the catalyst metal. Therefore, in the present embodiment, the electrode catalyst is preferably a metal-supported catalyst containing a catalyst metal, a support on which the catalyst metal is supported, and the organic nitrogen-containing compound. The organic nitrogen-containing compound may be contained in the catalyst ink for forming the cathode catalyst layer. Specifically, the catalyst ink for forming the cathode catalyst layer may include an electrode catalyst, a binder (e.g., an ionomer), a solvent, and the organic nitrogen-containing compound.

The ionomer is preferably an ionomer having a sulfonic acid group. Ionomers, also referred to as cation exchange resins, exist as clusters formed from ionomer molecules. The ionomer is not particularly limited, and for example, an ionomer known in the art can be used. Examples of the ionomer include fluororesin ionomers such as perfluorosulfonic acid polymers; sulfonated resin ionomers such as sulfonated polyether ketone, sulfonated polyether sulfone, sulfonated polyether ether sulfone, sulfonated polysulfone, sulfonated polysulfide, sulfonated polyphenylene; and sulfoalkylated resin ionomers such as sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene. Of these, fluororesin ionomers are preferred. One ionomer may be used alone or two or more ionomers may be used in combination.

The anode catalyst layer functions as a fuel electrode, i.e., a hydrogen electrode.

The anode catalyst layer includes at least an electrode catalyst and a binder. The binder is preferably an ionomer, and is preferably an ionomer having a sulfonic acid group. Examples of the ionomer having a sulfonic acid group include those described above. In one embodiment, the anode catalyst layer may include, in addition to the electrode catalyst and the ionomer, metallic ions selected from cerium ions and manganese ions, and a host compound capable of forming a clathrate compound with the metallic ions.

The electrode catalyst is not particularly limited, and for example, the above-described material can be used.

The ionomer having a sulfonic acid group is not particularly limited, and examples thereof include a polymer electrolyte resin having ion conductivity such as a perfluorosulfonic acid ionomer. Specific examples of the ionomer having a sulfonic acid group include Nafion, Aquavion (Solvay Corporation), and the like.

The membrane electrode assembly according to the present embodiment includes metallic ions selected from cerium ions and manganese ions, and a host compound capable of forming a clathrate compound with the metallic ions. Cerium ions and/or manganese ions function as a radical quenching agent and can trap and render harmless hydrogen peroxide radicals, thereby suppressing degradation of the membrane electrode assembly. Further, by adding the host compound for the metallic ions to the membrane electrode assembly, the migration of the metallic ions can be suppressed, and the deviation of the concentration in the plane direction can be reduced.

The metallic ions are selected from cerium ions and manganese ions. Cerium and manganese ions function as radical quenching agents. The radical quenching agent can facilitate conversion of the hydroxyl radical generated from the hydrogen peroxide into hydroxide ions, and can suppress degradation of the anode catalyst layer. For example, the reaction of hydroxyl radicals with cerium ions to hydroxide ions is as follows:

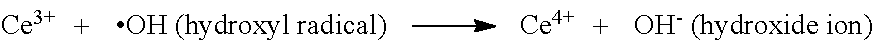

The cerium ion may be +3 valent or +4 valent. The manganese ion may be +3 valent or +4 valent.

The cerium salt for obtaining cerium ions is not particularly limited, and examples thereof include cerium nitrate, cerium carbonate, cerium acetate, cerium chloride, cerium sulfate, diammonium cerium nitrate, and cerium tetraammonium sulfate. As the cerium salt, one kind may be used alone, or two or more kinds may be used in combination. The cerium salt may be an organometallic complex salt. Examples of the organometallic complex salt include cerium acetylacetonate and the like.

The manganese salt for obtaining the manganese ion is not particularly limited, and examples thereof include manganese nitrate, manganese carbonate, manganese acetate, manganese chloride, and manganese sulfate. One manganese salt may be used alone, or two or more manganese salts may be used in combination.

The host compound in the present embodiment forms a clathrate compound with cerium ions or manganese ions as a guest compound. A clathrate compound refers to an addition compound having a form in which the metallic ions as a guest compound is included in a host compound. The host compound forming the clathrate compound includes, for example, a crown ether compound, a cyclodextrin compound, a cyclofan compound, or a salt thereof. One host compound may be used alone, or two or more host compounds may be used in combination.

The host compound is not particularly limited as long as it can form a clathrate compound with the metallic ions. The host compound preferably has a cyclic structure, and the number of ring members of the cyclic structure is preferably 15 or more, and preferably 18 or more. In one embodiment, the host compound is preferably a crown ether compound or a salt thereof. The crown ether compound is a compound having a ring having a repeating configuration of (—CH₂—CH₂—Y—) units or (—CH₂—CH₂—CH₂—Y—) units, wherein Y is at least one heteroatom selected from O, S, N and P. The crown ether compound traps a metallic ions in the ring structure to form a clathrate compound. The number of ring members of the crown ether compound is preferably 15 or more, and preferably 18 or more. The crown ether compound forms a clathrate compound with cerium ions or manganese ions as guest compounds. A clathrate compound refers to an addition compound having a form in which the metallic ions as a guest compound is included in a host compound. One crown ether compound may be used alone or two or more crown ether compounds may be used in combination.

Examples of the crown ether compound include a crown ether or a crown ether derivative. Examples of the crown ether include 15-crown-5-ether, 18-crown-6-ether, 21-crown-7-ether, and 24-crown-8-ether. In the present embodiment, the host compound is preferably a crown ether compound having an aromatic ring or an aliphatic ring or a salt thereof. The crown ether compound having an aromatic ring or an aliphatic ring has a high hydrophobicity due to its structure, and therefore has little transition to the cathode catalyst layer. Examples of the crown ether compound having an aromatic ring or an aliphatic ring include dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-ether, and compounds thereof in which aromatic rings or aliphatic rings are substituted with one or more substituents selected from a group consisting of halogen atoms (e.g., fluorine atoms or bromine atoms), a hydroxy group, an amino group, a nitro group, a formyl group, an alkyl group having 1 to 6 carbon atoms (e.g., a methyl group, an ethyl group, a propyl group, a butyl group), a hydroxyalkyl group having 1 to 6 carbon atoms, a carboxyalkyl group having 2 to 7 carbon atoms, and an aryl group having 6 to 14 carbon atoms (e.g., a phenyl group). The number of substituents is, for example, 1 to 6, 1 to 5, 1 to 4, 1 to 3, 1 to 2, and 1. These compounds may be used singly or in a combination of two or more.

In the present embodiment, the host compound is preferably a crown ether compound having a molecular weight of 300 or more or a salt thereof. By using a crown ether compound having a molecular weight of 300 or more, the migration inhibiting effect can be obtained, that is, the migration of the crown ether compound from the anode catalyst layer or the electrolyte membrane to the cathode catalyst layer can be suppressed.

Salts of crown ether compounds include, for example, nitrates, sulfates, carbonates, acetates, or propionates. One salt may be used alone, or two or more salts may be used in combination.

The host compound and the metallic ions may be contained in the anode catalyst layer, the solid polymer electrolyte membrane, or both. In the anode catalyst layer in the membrane electrode assembly of one embodiment, at least a portion of the host compound and the metallic ions form a clathrate compound.

When the anode catalyst layer contains a host compound and a metallic ions, the anode catalyst layer contains at least an electrode catalyst, an ionomer as an electrolyte, a metallic ions selected from a cerium ion and a manganese ion, and a host compound. The metallic ions can facilitate conversion of the hydroxyl radical generated from the hydrogen peroxide into the hydroxyl ion, and can suppress degradation of the anode catalyst layer.

The content of the metallic ions and the host compound in the anode catalyst layer is preferably 0.1 to 20 mass % with respect to the total solid content of the anode catalyst layer. The clathrate compound is regarded as a mixture of a metallic ions and a host compound with respect to the content. That is, in the case where the metallic ions and the host compound are separately or simply mixed and added into the anode catalyst layer, even if the clathrate compound is formed in the polymer electrolyte, the amount thereof is not taken into consideration, and only the total amount of the metallic ions and the host compound blended is set as the calculation target. When the clathrate compound is added to the anode catalyst layer after the clathrate compound is formed in advance, the amount of the clathrate compound is defined as the total amount of the metallic ions forming the clathrate compound and the host compound. Further, in addition to the metallic ions and the host compound forming the clathrate compound, if there are a metallic ions and a host compound that do not form the clathrate compound, they are also subject to calculation.

The content of the metallic ions in the anode catalyst layer is preferably 0.1 to 20 μg/cm². The content of the host compound in the anode catalyst layer is preferably 0.1 to 20 μg/cm².

Regarding the relative ratio of the metallic ions and the host compound in the present embodiment, the molar ratio of the host compound to the metallic ions ([number of moles of the host compound]/[number of moles of the metallic ions]) is, for example, 0.1 to 10, preferably 0.2 to 7.5, and preferably 0.4 to 5.0. That is, the content of the host compound is, for example, 0.1 to 10 mol, preferably 0.2 to 7.5 mol, and preferably 0.4 to 5.0 mol with respect to 1 mol of the metallic ions. Also in this relative ratio, the clathrate compound is regarded as a mixture of both as described above.

When the solid polymer electrolyte membrane contains a host compound and a metallic ions, for example, a solid polymer electrolyte membrane containing a host compound and a metallic ions can be obtained by the following method.
(1) A method in which a solid polymer electrolyte membrane is immersed in a solution containing a metallic ions to exchange a group such as a sulfonic acid group with a metallic ions, and then immersed in a solution containing a host compound to contain a host compound in the membrane.
(2) A method in which a compound containing a metallic ions (for example, a cerium salt) is added to a dispersion liquid of a polymer electrolyte to exchange a group such as a sulfonic acid group with a metallic ions, and then a solution or a solid containing a host compound is added to the dispersion liquid, and the resulting liquid is used to form a film by coating.
(3) A method of forming a clathrate compound by reacting a compound containing a metallic ions (for example, a cerium salt) with a host compound in a solvent to form a clathrate compound, and then immersing the solid polymer electrolyte membrane in a solution in which the clathrate compound is dissolved in the solvent to ion-exchange a group such as a sulfonic acid group with the clathrate compound, whereby the clathrate compound is contained in the membrane.
(4) A method of forming a clathrate compound by reacting a compound containing a metallic ions (for example, a cerium salt) with a host compound in a solvent to form a clathrate compound, then adding the clathrate compound or a solution thereof to a dispersion liquid of a polymer electrolyte, and forming a film by coating using the obtained liquid.

### Method for Manufacturing Membrane Electrode Assembly

The catalyst layer can be formed by, for example, a step of preparing a catalyst ink (for example, a solid content concentration of about 10%) containing at least an electrode catalyst, an ionomer, and a solvent, a step of forming a catalyst layer on the surface of the substrate by applying the catalyst ink to the surface of the substrate and volatilizing the solvent in the coating film, and a step of transferring the catalyst layer on the surface of the substrate to the electrolyte membrane. Alternatively, the catalyst layer can be formed by a method in which the catalyst ink is directly applied to the solid polymer electrolyte membrane instead of the base material. By forming the cathode catalyst layer and the anode catalyst layer on the solid polymer electrolyte membrane, a membrane electrode assembly can be produced.

Examples of the method for applying the catalyst ink include a spray method, a blade coating method using a doctor blade or an applicator, a die coating method, a reverse roll coater method, and an intermittent die coating method.

The anode catalyst layer may contain the metallic ions and the host compound in a catalyst ink for forming the anode catalyst layer. Specifically, the catalyst ink for forming the anode catalyst layer may include an electrode catalyst, an ionomer (e.g., an ionomer having a sulfonic acid group), the metallic ions, a host compound, and a solvent. The metallic ions and the host compound may be added separately or in the form of a complex of both.

In the present embodiment, the cathode catalyst layer is formed to contain the organic nitrogen-containing compound.

### Membrane Electrode Assembly and Specific Configuration of Polymer Electrolyte Fuel Cell

In a polymer electrolyte fuel cell, a membrane electrode assembly (MEA) in which catalytic layers (electrodes) are bonded to both surfaces of a solid polymer electrolyte membrane is used as a basic unit. In addition, in a polymer electrolyte fuel cell, a gas diffusion layer is generally disposed outside the catalyst layer. The gas diffusion layer is for supplying a reaction gas and electrons to the catalyst layer, and carbon paper, carbon cloth, and the like are used. In addition, the catalyst layer is a portion that serves as a reaction field of the electrode reaction.

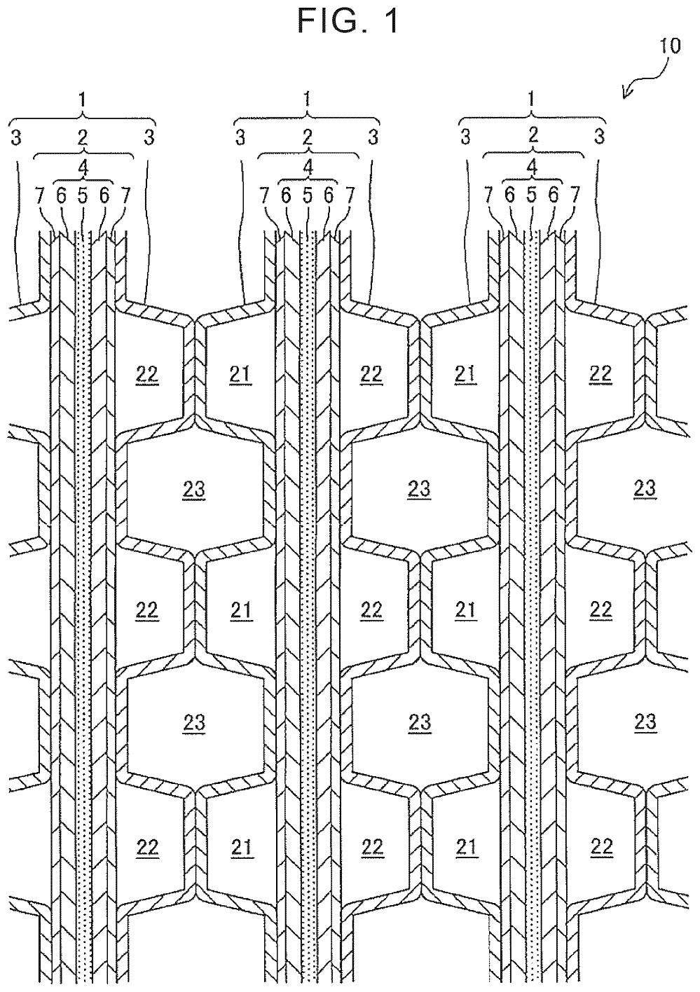

Hereinafter, the configurations of the membrane electrode assembly and the polymer electrolyte fuel cell will be described with reference to FIG. 1. FIG. 1 is a schematic cross-sectional view for explaining a configuration example of a polymer electrolyte fuel cell according to the present embodiment, and is a cross-sectional view of a main part of a fuel cell 10 as an example. A polymer electrolyte fuel cell includes a stack of single cells composed of a power generator and a fuel cell separator disposed on both sides of the power generator. The plurality of single cells is stacked in the stacking direction, and each single cell is electrically connected in series. As shown in FIG. 1, a plurality of unit cells 1, which are basic units, are stacked in the fuel cell 10. Each unit cell 1 is a polymer electrolyte fuel cell that generates an electromotive force by an electrochemical reaction between an oxidizing gas (e.g., air) and a fuel gas (e.g., hydrogen). The unit cell 1 includes a membrane electrode gas diffusion layer assembly (MEGA: Membrane Electrode & Gas Diffusion Layer Assembly) 2 having gas diffusion layers (GDL: Gas Diffusion Layer) 7 disposed on both sides thereof, and separators 3 contacting MEGA2 so as to partition MEGA2. In the present embodiment, MEGA2 is sandwiched between a pair of separators 3 and 3.

MEGA2 comprises a membrane electrode assembly (MEA: Membrane Electrode Assembly) 4 and gas-diffusion layers 7, 7 arranged on both sides thereof. The membrane electrode assembly 4 includes an electrolyte membrane 5 and a pair of electrodes 6 and 6 bonded to each other so as to sandwich the electrolyte membrane 5. The electrolyte membrane 5 is, for example, a proton-conductive ion exchange membrane formed of a solid polymer material. The electrode 6 includes, for example, a porous carbon material on which a catalyst such as platinum is supported. An electrode 6 disposed on one side of the electrolyte membrane 5 functions as an anode, and an electrode 6 on the other side functions as a cathode. The gas diffusion layer 7 is formed of a conductive member having gas permeability. Examples of the conductive member having gas permeability include a carbon porous body such as carbon paper or carbon cloth, and a metal porous body such as a metal mesh or a metal foam. In the present embodiment, the anode electrode is formed of an anode catalyst layer, and the cathode electrode is formed of a cathode catalyst layer.

Hereinafter, the present embodiment will be described with reference to examples.

Preparation of Electrode Catalyst 1 (with Monomer)

Platinum-cobalt alloy particles (metal ratio 0.13 atm % other than platinum, mean particle diameter: 4 nm from 3) as a catalyst metal, 1,3,5-triazine-2,4,6-triamine (melamine, manufactured by Fujifilm Wako Pure Chemical Industries, Ltd.) as an organic nitrogen-containing compound, and a metal-supported catalyst (electrode catalyst 1) containing carbon as a support were prepared (metal-supported ratio: 42 wt %).

The ratio of the mass of the additive (organic nitrogen-containing compound) to the mass of the carrier (additive mass/carrier mass) calculated from the charge amount was 0.1.

### Preparation of Electrode Catalyst 2 (Containing Polymer)

A metal supported catalyst (electrode catalyst 2) containing platinum cobalt alloy particles (metal ratio 0.13 atm % other than platinum, mean particle diameter: 4 nm from 3) as a catalyst metal, a polymer of 1,3,5-triazine-2,4,6-triamine (melamine, manufactured by Fujifilm Wako Pure Chemical Industries, Ltd.) as an organic nitrogen-containing compound, and carbon as a support was prepared (metal supported ratio: 42 wt %).

The ratio of the mass of the additive (organic nitrogen-containing compound) to the mass of the platinum catalyst (additive weight/catalyst weight) calculated from the charge amount was 0.1.

### Preparation of Electrode Catalyst 3 (Compound-Free)

Platinum-cobalt alloy particles (metal ratio 0.13 atm % other than platinum, mean particle diameter: 4 nm from 3) as a catalyst metal and a metal-supported catalyst (electrode catalyst 3) containing carbon as a support were prepared (metal-supported ratio: 42 wt %).

### Preparation of Clathrate Compounds (Complexes: Ce-Ligands)

To a 100 mL eggplant flask, benzo-18-crown-6-ether (also called B18CRE) (3.12 g, 0.01 mol) and cerium (III) nitrate hexahydrate (4.34 g, 0.01 mol) were weighed, ethanol (20 mL) and water (20 mL) were added, and the mixture was stirred at room temperature for 24 hours. After that, the solution was removed by an evaporator, and then dried in vacuo at 60° C. for 1 hour to obtain a white solid (complex: Ce-ligand). FT-IR confirmed that the peaks derived from the ether group shifted in low wave number, and confirmed that the crown ether compound included Ce.

### First Embodiment

### Formation of a Cathode Catalyst Layer

The electrode catalyst 2 (containing a polymer) was dispersed in an ionomer solution (Nafion DE2020) containing water and ethanol using a bead mill to prepare a catalyst ink. The water/alcohol weight ratio in the catalyst ink was about 1. The catalyst ink was coated on a polytetrafluoroethylene sheet and dried to form a cathode catalyst layer.

Pt basis weight of the cathode catalyst-layer was 0.2 mg/cm², and the weight-ratio (I/C) of the ionomer to the support was 1.0.

### Formation of the Anode Catalyst Layer

As the electrode catalyst, a platinum-supported carbon catalyst (TEC10E30E, 30% platinum-supported carbon, manufactured by Tanaka Kiyoshi Kogyo Co., Ltd.) was used. The electrode catalyst and the complex were dispersed in an ionomer solution (DE2020) containing water, ethanol, and Nafion®, to prepare a catalyst ink. The catalyst ink was coated on a polytetrafluoroethylene sheet and dried to form an anode catalyst layer.

Pt basis weight of the anode catalyst layer was 0.1 mg/cm², and the cerium-ion concentration was 6 μg/cm². The crown ether compound is added by the above procedure in a molar ratio of Ce:ligand=1:1. The crown ether compound was 13.5 μg/cm². The weight fraction (I/C) of ionomer to carbon was 1.0.

### Preparation of Membrane Electrode Assembly

Each of the obtained cathode catalyst layer and anode catalyst layer was thermally transferred to both surfaces of a Nafion® membrane (NR211) to prepare a membrane electrode assembly E1. Thermal transfer was performed at 140° C., 50 kgf/cm² (4.90 MPa) and 5 min. The electrode area of the membrane electrode assembly for the initial performance test was 1 cm×1 cm (1 cm²). The electrode area of the membrane electrode assembly for the durability test was 3.6 cm×3.6 cm (12.96 cm²). A test cell was prepared by sandwiching the membrane electrode assembly with a paper diffusing layer with a water-repellent layer (GDL).

### Second Embodiment

A membrane electrode assembly E2 was prepared in the same manner as in Example 1, except that the electrode catalyst 1 (containing a monomer) was used instead of the electrode catalyst 2 (containing a polymer).

### Comparative Example 1

A membrane electrode assembly C1 was prepared in the same manner as in Example 1, except that only cerium nitrate was added in place of the complex in the anode catalyst layer, and electrode catalyst 3 (compound-free) was used in place of electrode catalyst 2 (polymer-containing).

### Comparative Example 2

A membrane electrode assembly C2 was prepared in the same manner as in Example 1, except that the electrode catalyst 3 (compound-free) was used instead of the electrode catalyst 2 (polymer-containing).

### Comparative Example 3

A membrane electrode assembly C3 was prepared in the same manner as in Example 1 except that only cerium nitrate was added in place of the complex in the anode catalyst layer.

### Comparative Example 4

A membrane electrode assembly C4 was prepared in the same manner as in Example 2 except that only cerium nitrate was added in place of the complex in the anode catalyst layer.

### Performance Evaluation

### Initial Performance Test

Cell evaluations were performed using a membrane electrode assembly (electrode area: 12.96 cm²) for early performance testing. The current-voltage properties were evaluated under low humidification conditions (cell temperature 95° C., humidity 30% RH) and the performance (voltage) at 1.5 A/cm² was measured. The sweep rate in evaluating the current-voltage properties was 20 mA/s and obtained by anodic sweep. Also, the cell pressure was 150 kPa, the anode gas species was hydrogen, the anode gas flow rate was 1.0 L/min, the cathode gas species was air, and the cathode gas flow rate was 2.0 L/min. The results are given in Table 1.

### Durability Test: Voltage Drop Rate

Using the above test cell (electrode area: 12.96 cm²), a durability test was performed for 300 hours in a low humidification environment (cell temperature: 95° C., humidity 30% RH) and a low current density (0.2 A/cm²) in which degradation of the electrolyte membrane is likely to occur. The cell pressure was 150 kPa, the anode gas species was hydrogen, the anode gas flow rate was 1.0 L/min, the cathode gas species was air, and the cathode gas flow rate was 2.0 L/min. After the durability test, hydrogen/air was supplied to evaluate the properties of the polymer electrolyte fuel cell at the current-density 1.5 A/cm² under the conditions of the initial performance test described above, and the relation between the cell voltage at the initial stage of operation and the elapsed time after operation and the cell voltage was measured. The results are shown in Table 1 below.

TABLE 1

| | | | | Comparative | Comparative | Comparative | Example | Comparative | |
|---|---|---|---|---|---|---|---|---|---|
| | | | | Example 1 | Example 2 | Example 3 | 1 | Example 4 | Example 2 |
| An catalyst | Radical | Cerium nitrate | μg/cm² | 6 | 6 | 6 | 6 | 6 | 6 |
| layer | quenching | | | | | | | | |
| | agent | | | | | | | | |
| | Host | B18CRE | μg/cm² | — | 13.5 | — | 13.5 | — | 13.5 |
| | compound | | | | | | | | |
| Ca catalyst | Organic | Melamine | μg/cm² | — | — | Addition | Addition | — | — |
| layer | nitrogen- | polymer | | | | | | | |
| | containing | Melamine | μg/cm² | — | — | — | — | Addition | Addition |
| | compound | monomer | | | | | | | |
| Initial | Initial | 95° C., 30% | mV | 514 | 474 | 524 | 526 | 520 | 519 |
| performance | voltage | RH, 1.5 A/cm² | | | | | | | |
| | Difference in | CRE addition- | mV | | −40 | | 2 | | −1 |
| | initial | Without CRE | | | | | | | |
| | voltage | | | | | | | | |
| Durability | Voltage after | 95° C., 30% | mV | 448 | 458 | 449 | 499 | 440 | 490 |
| | durability | RH, 1.5 A/cm² | | | | | | | |
| | Voltage | | % | 87% | 97% | 86% | 95% | 85% | 94% |
| | retention | | | | | | | | |

The upper limit value and/or the lower limit value of the numerical range described in the present specification can be arbitrarily combined to define a preferable range. For example, the upper limit value and the lower limit value of the numerical range can be arbitrarily combined to define a preferable range, the upper limit value of the numerical range can be arbitrarily combined to define a preferable range, and the lower limit value of the numerical range can be arbitrarily combined to define a preferable range.

Although the present embodiment has been described in detail above, the specific configuration is not limited to this embodiment, and even if there are design changes within a range not departing from the gist of the present disclosure, they are included in the present disclosure.

What is claimed is:

1. A membrane electrode assembly, comprising:
a solid polymer electrolyte membrane;
an anode catalyst layer that is disposed on one face of the solid polymer electrolyte membrane; and
a cathode catalyst layer that is disposed on another face of the solid polymer electrolyte membrane, wherein
the membrane electrode assembly includes metallic ions that are selected from cerium ions and manganese ions, and a host compound that is configured to create a clathrate compound with the metallic ions,
the cathode catalyst layer includes an electrode catalyst, a binder, and an organic nitrogen-containing compound,
the electrode catalyst includes a metal-carried catalyst including a catalyst metal and a carrier that carries the catalyst metal, and
the organic nitrogen-containing compound is at least one compound that is selected from a group consisting of a compound of Formula (1) below, a compound of Formula (2) below, and a compound of Formula (3) below, or a polymer of the compound that is selected, 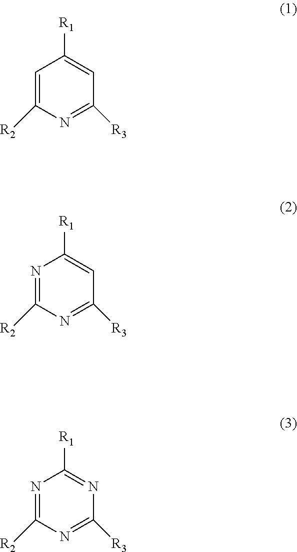
where, in Formulae (1) through (3), R₁, R₂, and R₃ are each independently an amino group, a thiol group, a hydroxyl group, an alkylamino group with 1 to 10 carbon atoms, or an alkyl group with 1 to 10 carbon atoms, in which at least one of the carbon atoms in the alkylamino group and the alkyl group may be substituted with an oxygen atom, a sulfur atom, or a nitrogen atom, and at least one of hydrogen atoms in the alkylamino group and the alkyl group may be substituted with a fluorine atom, a chlorine atom, a bromine atom, or an iodine atom.

2. The membrane electrode assembly according to claim 1, wherein the host compound is a crown ether compound or a salt of the crown ether compound.

3. The membrane electrode assembly according to claim 2, wherein molecular weight of the host compound is no less than 300.

4. The membrane electrode assembly according to claim 2, wherein the host compound is a crown ether compound with an aromatic ring or an aliphatic ring, or a salt of the crown ether compound.

5. The membrane electrode assembly according to claim 1, wherein the catalyst metal includes at least one type that is selected from a group consisting of platinum particles, platinum alloy particles, and composite particles containing platinum.
